(19) United States
(12) Patent Application Publication
(10) Pub. No.: US 2009/0303640 A1
(43) Pub. Date: Dec. 10, 2009

(54) MAGNETO-RESISTANCE EFFECT ELEMENT PROVIDED WITH CURRENT LIMITING LAYER INCLUDING MAGNETIC MATERIAL

(75) Inventors: Tomohito Mizuno, Tokyo (JP); Koji Shimazawa, Tokyo (JP); Yoshihiro Tsuchiya, Tokyo (JP); Daisuke Miyauchi, Tokyo (JP); Takahiko Machita, Tokyo (JP); Shinji Hara, Tokyo (JP); Tsutomu Chou, Tokyo (JP); Hironobu Matsuzawa, Tokyo (JP); Toshiyuki Ayukawa, Tokyo (JP); Tsuyoshi Ichiki, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TDK CORPORATION, Tokyo (JP)

(21) Appl. No.: 12/109,651

(22) Filed: Apr. 25, 2008

(51) Int. Cl. G11B 5/33

(52) U.S. Cl. 360/324; G9B/5.104

(57) ABSTRACT

A magneto resistance effect element includes a first magnetic layer, a second magnetic layer and a spacer layer interposed between the first and second magnetic layers. The magneto resistance effect element is configured to allow sense current to flow in a direction that is perpendicular to film planes of the first magnetic layer, the second magnetic layer and the spacer layer so that a relative angle between a magnetization direction of the first magnetic layer and a magnetization direction of the second magnetic layer varies depending on an external magnetic field. The present invention aims at providing a magneto resistance effect element which ensures high resistance to sense current, while limiting the influence of the current limiting layer on the magnetic layer, and which thereby achieves a high magneto resistance ratio.

### BACKGROUND OF THE INVENTION

1. Field of the Invention

The present invention relates to a magneto resistance effect element, and in particular, relates to the configuration of a magnetic layer that is provided adjacent to a spacer layer and that provides magneto-resistance effect.

2. Description of the Related Art

Giant magneto-resistance (GMR) elements are known as reproducing elements (magneto resistance effect elements) for a thin-film magnetic head. Hitherto, current-in-plane (CIP)-GMR elements in which a sense current flows in the horizontal direction with respect to the film planes thereof have been mainly used. Recently, elements in which a sense current flows in the direction that is perpendicular to the film planes thereof have been developed in order to achieve a higher recoding density. CPP (Current Perpendicular to the Plane)—GMR elements that utilize the GMR effect are known as elements of this type.

A conventional CPP-GMR element has an MR stack that includes a magnetic layer (a free layer) whose magnetization direction varies with an external magnetic field, a magnetic layer (a pinned layer) whose magnetization direction is fixed relative to the external magnetic field and a nonmagnetic intermediate layer (a spacer layer) that is sandwiched between the pinned layer and the free layer. The pinned layer is generally constituted as a so-called synthetic pinned layer having two magnetic layers that are antiferromagnetically coupled with each other. An antiferromagnetic layer is provided adjacent to the synthetic pinned layer. Bias magnetic layers for applying a bias magnetic field to the free layer are provided on both sides of the MR stack with regard to the track width direction. The free layer is magnetized into a single magnetic domain by the bias field applied from the bias magnetic layers. This enables, with higher linearity, a change in the resistance to a change in the external magnetic field, while effectively limiting the Barkhausen noise. The relative angle between the magnetization direction of the free layer and that of the pinned layer varies according to an external magnetic field, and the variation in the relative angle causes a change in the electric resistance to the sense current that flows in the direction that is perpendicular to the film planes of the MR stack. These properties are used to detect the external magnetic field.

The CPP-GMR elements are disadvantageous in that they have inherently low element resistance, which makes it difficult to ensure a sufficient high magneto resistance ratio. Thus, various techniques have been developed to solve this problem.

The description of Japanese Patent Laid-Open Publication No. 2004-165254 discloses a technique for providing a spacer layer with a resistance distribution layer. The resistance distribution layer is formed of a magnetic metal, such as Co, Fe and Ni, and an oxide of Ta or Al etc. having smaller electronegativity than the former. The former serves as a path for sense current, while the lafter, which is an insulating material, hardly allows sense current to flow. This configuration enables an increase in the element resistance, and therefore an improvement of the magneto resistance ratio.

The description of Japanese Patent Laid-Open Publication No. 2004-355682 discloses a technique for partially oxidizing a ferromagnetic layer that is made of FeCo and for using the layer in a spacer layer. The partially oxidized layer, which is sandwiched between Cu layers on both sides, includes a non-oxidized region dotted with oxidized regions.

The description of Japanese Patent Laid-Open Publication No. 2006-49358 discloses a technique for providing an oxidized magnetic layer in a spacer layer. The oxidized magnetic layer is formed of an antiferromagnetic oxide or a spinel oxide or the like.

The description of Japanese Patent Laid-Open Publication No. 2003-8102 discloses a technique for providing a resistance adjusting layer that also serves as a spacer layer, between a pinned layer and a free layer. The resistance adjusting layer is formed of GaAs, CoSi, ZnO or the like.

As described above, prior art discloses a wide variety of techniques for providing a spacer-layer with a high resistance regions. However, a high resistance regions also may be provided in the free layer or in the pinned layer in order to increase the element resistance. The description of Japanese Patent Laid-Open Publication No. 2004-31545 discloses a technique for providing a free layer having two magnetic layers, made of NiFe, CoFe or the like, and having a current limiting layer formed therebetween. The current limiting layer includes an insulating film having holes therein which are filled with a conductive film. The insulating film is formed of an oxidized or nitrided film, and the conductive film is formed of nonmagnetic material, such as gold (Au) or chrome (Cr). The holes in the insulating film are formed using the property of the oxidized or nitrided conductive film to easily aggregate into a discontinuous film during being deposited by sputtering.

The technique disclosed in the description of Japanese Patent Laid-Open Publication No. 2004-31545 is advantageous in that it increases resistance to the sense current, but is problematic in that the two magnetic layers that sandwich the current limiting layer are magnetically separated because the conductive film is formed of a nonmagnetic material, such as Au or Cr. In other words, the sense current loses spin selectivity when it passes through the nonmagnetic material, and the loss of the spin selectivity, in turns, decreases the magneto-resistance effect. This imposes limitations on an increase in the magneto resistance ratio.

### SUMMARY OF THE INVENTION

The present invention is directed to a magneto resistance effect element comprising a first magnetic layer, a second magnetic layer and a spacer layer interposed between the first and second magnetic layers, wherein the magneto resistance effect element is configured to allow sense current to flow in a direction that is perpendicular to film planes of the first magnetic layer, the second magnetic layer and the spacer layer so that a relative angle between a magnetization direction of the first magnetic layer and a magnetization direction of the second magnetic layer varies depending on an external magnetic field, wherein at least the first magnetic layer or the second magnetic layer includes a current limiting layer. The present invention aims at providing a magneto resistance effect element which ensures high resistance to sense current, while limiting the influence of the current limiting layer on the magnetic layer, and which thereby achieves a high magneto resistance ratio.

A magneto resistance effect element according to an embodiment of the invention comprises a first magnetic layer, a second magnetic layer and a spacer layer interposed between the first and second magnetic layers. The magneto resistance effect element is configured to allow sense current to flow in a direction that is perpendicular to film planes of the first magnetic layer, the second magnetic layer and the spacer layer so that a relative angle between a magnetization direction of the first magnetic layer and a magnetization direction of the second magnetic layer varies depending on an external magnetic field. At least the first magnetic layer or the second magnetic layer includes: an inner ferromagnetic layer that is in contact with the spacer layer; a current limiting layer that is in contact with the inner ferromagnetic layer on a surface of the inner ferromagnetic layer, the surface being opposite to a surface of the inner ferromagnetic layer on which the inner ferromagnetic layer is in contact with the spacer layer; and an outer ferromagnetic layer that is in contact with the current limiting layer on a surface of the current limiting layer, the surface being opposite to a surface of the current limiting layer on which the current limiting layer is in contact with the inner ferromagnetic layer. The current limiting layer includes: low resistance magnetic regions that are formed of a ferromagnetic material that includes an element that is common to the inner ferromagnetic layer and to the outer ferromagnetic layer; and high resistance regions having higher resistance to the sense current than the low resistance magnetic regions. The low resistance magnetic regions electrically connect the inner ferromagnetic layer with the outer ferromagnetic layer.

According to the magneto resistance effect element thus configured, the current limiting layer includes low resistance magnetic regions and high resistance regions therein. This configuration enables concentration of sense current on the low resistance magnetic regions, and resultantly increases the electric resistance. Since the low resistance magnetic regions is formed of a ferromagnetic material that includes an element that is common to the inner ferromagnetic layer and to the outer ferromagnetic layer, the inner and the outer ferromagnetic layers are magnetically coupled with each other via the low resistance magnetic regions. As a result, both the inner and the outer magnetic layers can effectively contribute to a change in magneto resistance.

Thus, the present invention can provide a magneto resistance effect element which ensures high resistance to the sense current, while limiting the influence of the current limiting layer on the magnetic layer, and which thereby achieves a high magneto resistance ratio.

The above and other objects, features and advantages of the present invention will become apparent from the following description with reference to the accompanying drawings which illustrate examples of the present invention.

### BRIEF DESCRIPTION OF THE DRAWINGS

FIG. 1 is a cross sectional view of the main portion of a thin-film magnetic head that uses a magneto resistance effect element according to a first embodiment;

FIG. 2 is an enlarged view of the main portion of the air bearing surface of the magneto resistance effect element according to the first embodiment;

FIG. 3 is a detailed cross sectional view of the free layer of the magneto resistance effect element according to the first embodiment;

FIG. 4 is a detailed cross sectional view of the free layer of the magneto resistance effect element according to a second embodiment;

FIG. 5 is an enlarged view of the main portion of the air bearing surface of the magneto resistance effect element according to a third embodiment;

FIG. 6 is a detailed cross sectional view of the free layer of the magneto resistance effect element according to the third embodiment;

FIG. 7 is a cross sectional view of the magneto resistance effect element according to the third embodiment, viewed from the same direction as in FIG. 1;

FIG. 8 is a schematic diagram illustrating the working principle of the magnetic detecting element of the third embodiment;

FIG. 9 is a detailed cross sectional view of the free layer of the magneto resistance effect element according to the fourth embodiment;

FIG. 10 is a graph illustrating the relationship among the thickness of the inner ferromagnetic layer, the thickness of the current limiting layer and the magneto resistance ratio according to the third embodiment;

FIG. 11 is a graph illustrating the relationship between the thickness of the current limiting layer and the magneto resistance ratio;

FIG. 12 is a graph illustrating the relationship among the thickness of the inner ferromagnetic layer, the thickness of the current limiting layer and the magneto resistance ratio according to the fourth embodiment;

FIG. 13 is a plan view of a wafer which is used to manufacture the magneto resistance effect element of the present invention;

FIG. 14 is a perspective view of a slider of the present invention;

FIG. 15 is a perspective view of a head arm assembly which includes a head gimbal assembly which incorporates a slider of the present invention;

FIG. 16 is a side view of a head arm assembly which incorporates sliders of the present invention; and

FIG. 17 is a plan view of a hard disk drive which incorporates sliders of the present invention.

### DETAILED DESCRIPTION OF THE PREFERRED EMBODIMENTS

### First Embodiment

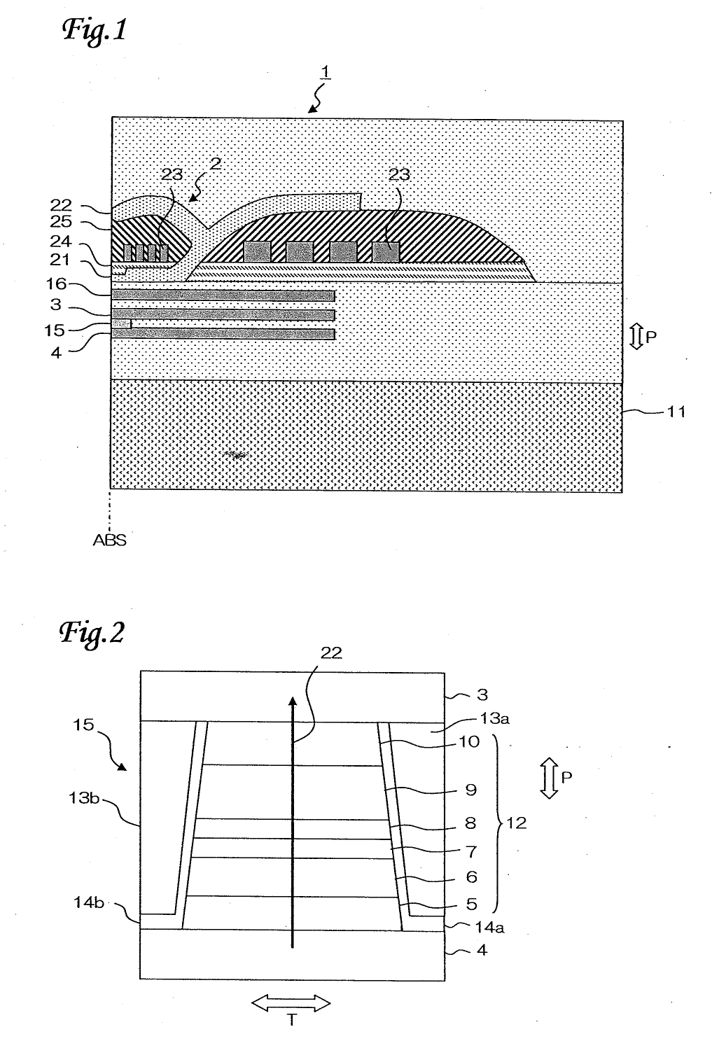

The first embodiment of the present invention will be described below with reference to the drawings. The magneto resistance effect element of the present invention can be suitably used, in particular, for the read head portion of a thin-film magnetic head for a hard disk drive. FIG. 1 is a cross sectional view of the main portion of a thin-film magnetic head using the magneto resistance effect element according to the present embodiment. FIG. 2 is an enlarged view of the main portion of the air bearing surface of the magneto resistance effect element of the thin-film magnetic head illustrated in FIG. 1. The term “air bearing surface” refers to the surface of a thin-film magnetic head that faces a recording medium.

Thin-film magnetic head 1 includes magneto resistance effect element 15 and write head portion 2. Magneto resistance effect element 15 is interposed between upper shield electrode layer 3 and lower shield electrode layer 4 that is formed on substrate 11, with the leading end thereof exposed on air bearing surface ABS. Magneto resistance effect element 15 is adapted to allow sense current 22 to flow in direction P that is perpendicular to the film planes under a voltage applied between upper and lower shield electrode layers 3 and 4. The magnetic field emitted from a recording medium, not shown, at the position that is opposite to magneto resistance effect element 15 changes according to the rotation of the recording medium. The change in the magnetic field is detected in the form of a change in electric resistance based on the magneto-resistance effect. Using this principle, magneto resistance effect element 15 reads out magnetic information written in the recording medium.

Magneto resistance effect element 15 has MR stack 12. Table 1-1 shows the layer configuration of MR stack 12. In the table, the layers are shown in the order of stacking from the bottom row to the top row, starting with buffer layer 5, which is located on the side of lower shield electrode layer 4, toward cap layer 10, which is located on the side of upper shield electrode layer 3. In the table, the numerals in the column of “Composition” indicate the atomic percents of the elements. MR stack 12 has buffer layer 5, antiferromagnetic layer 6, pinned layer 7, spacer layer 8, free layer 9 and cap layer 10 formed on lower shield electrode layer 4 in this order.

TABLE 1-1

| Layer Configuration | | Composition | Thickness (nm) |
|---|---|---|---|
| Cap Layer 10 | | Ta | 2 |
| | | Ru | 1 |
| Free Layer 9 | Outer Ferromagnetic Layer 91 | 90Co10Fe | 2 |
| (Second Magnetic Layer 9) | Current Limiting Layer 92 | ZnO + CoFe | 0.4~2.0 |
| | Inner Ferromagnetic Layer 91 | CoFe | 0.4~1.4 |
| Spacer Layer 8 | | Cu | 0.8 |
| Pinned Layer 7 | Second Pinned Lyer 73 | 30Co70Fe | 1.3 |
| (First Magnetic Layer 7) | | Cu | 0.2 |
| | | 30Co70Fe | 1.3 |
| | | 90Co10Fe | 1 |
| | Non-magnetic Intermediate Layer 72 | Ru | 0.8 |
| | First Pinned Lyer 71 | 70Co30Fe | 3 |

| | | |
|---|---|---|
| Anti-ferromagnetic Layer 6 | IrMn | 5.5 |
| Buffer Layer 5 | NiCr | 5 |
| | Ta | 1 |

Pinned layer 7 is a magnetic layer (first magnetic layer) whose magnetization direction is fixed with respect to an external magnetic field and free layer 9 is a magnetic layer (second magnetic layer) whose magnetization direction can vary depending on the external magnetic field. Spacer layer 8 is interposed between pinned layer 7 and free layer 9. Application of an external magnetic field in a state in which sense current 22 flows through the layers (in a direction that is perpendicular to the film planes) causes a change in the relative angle between the magnetization direction of free layer 7 and that of pinned layer 9, and thereby causes a change in the resistance to sense current 22. By detecting the change in the resistance, the intensity of the external field can be detected, and accordingly, the magnetic data recorded in a recording medium can be read out. Now, the main layers that constitute thin-film magnetic head 1 will be described in detail.

Lower shield electrode layer 4 that consists of a NiFe layer having a thickness of about 1 μm is formed on substrate 11, which is made of AlTiC (Al₂O₃—TiC), via a seed layer made of alumina (Al₂O₃), not shown. Buffer layer 5 is formed on lower shield electrode layer 4. Buffer layer 5 has a stack of a metallic layer made of a Ta layer and a seed layer made of a NiCr layer. Alternatively, buffer layer 5 may be a single layer made of NiCr.

Pinned layer 7 is provided on buffer layer 5 via antiferromagnetic layer 6. Antiferromagnetic layer 6, which serves to fix the magnetization of first pinned magnetic layer 71 described later, may be formed of a manganese alloy, such as PtMn, RuRhMn, FeMn, NiMn, PdPtMn, RhMn or CrMnPt, in addition to IrMn.

Pinned layer 7, which is a synthetic pinned layer in the present embodiment, is formed by stacking first pinned magnetic layer 71 made of CoFe, nonmagnetic intermediate layer 72 made of Ru and second pinned magnetic layer 73 in this order. Second pinned magnetic layer 73 has a stack of a 90Co10Fe layer, a 30Co70Fe layer and a Cu layer. Second pinned magnetic layer 73 is fixedly magnetized in a predetermined direction due to the antiferromagnetic coupling with first pinned magnetic layer 71 that occurs via nonmagnetic intermediate layer 72. The Cu layer inserted into second pinned magnetic layer 73 forms interfaces between Cu and CoFe in second pinned magnetic layer 73 that contributes to the magneto-resistance effect. This enhances the boundary scattering effect and improves the magneto resistance ratio. The Cu layer may be inserted into second pinned magnetic layer 73 at any location, without being limited to the location shown in the example of Table 1. The synthetic pinned layer limits the leakage of a magnetic field as a whole by cancelling out the magnetic moments of first pinned magnetic layer 71 and second pinned magnetic layer 73, and at the same time, firmly fixes the magnetization direction of second pinned magnetic layer 73. Pinned layer 7 is not limited to the synthetic pinned layer, and may be formed of a single layer that is not provided with first pinned magnetic layer 71 and nonmagnetic intermediate layer 72. Nonmagnetic intermediate layer 72 may be formed of Rh or Cr, in addition to Ru.

Spacer layer 8 is made of Cu and has a thickness of about 0.8 nm. Spacer layer 8 may be formed of a nonmagnetic metal (Cu, Zn, Ag and Au) or a semiconductor (ZnO, ZnN, SiO, SiN, SiON, SiC, SnO, In₂O₃ and indium-tin-oxide (ITO)) that exhibits the magneto-resistance effect. Spacer layer 8 may have a configuration in which a semiconductor or an insulator is inserted into a nonmagnetic metal, such as Cu/ZnO/Cu. Here, the notation of, for example, A/B/C shows that A, B and C are stacked in this order.

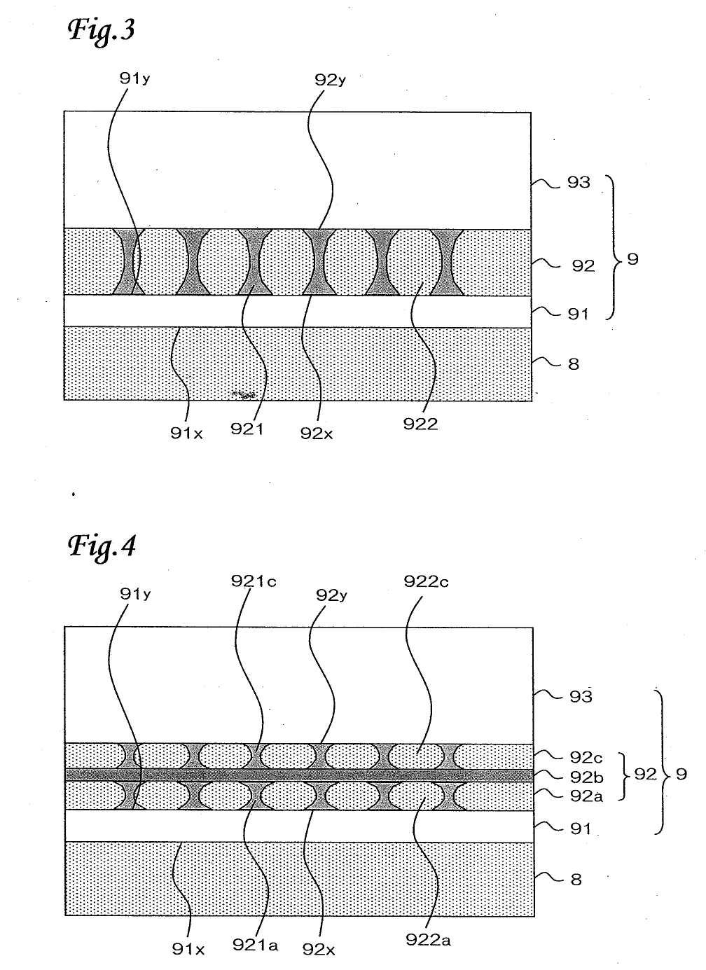

FIG. 3 is a detailed cross sectional view of the free layer. Free layer 9 includes inner ferromagnetic layer 91 that is in contact with spacer layer 8, current limiting layer 92 that is in contact with inner ferromagnetic layer 91 on surface 91y that is opposite to surface 91x on which inner ferromagnetic layer 91 is in contact with spacer layer 8 and outer ferromagnetic layer 93 that is in contact with current limiting layer 92 on surface 92y that is opposite to surface 92x on which current limiting layer 92 is in contact with inner ferromagnetic layer 91.

Inner ferromagnetic layer 91 is formed of CoFe having a composition ranging between 90Co10Fe and 30Co70Fe. Inner ferromagnetic layer 91 preferably has a thickness from 0.4 nm to 1.4 nm, as described later. Inner ferromagnetic layer 91 may also be formed of CoFeB. In this case, the atomic fraction of boron (B) is preferably 20% or less. The composition of CoFe in CoFeB preferably ranges between 90Co10Fe and 70Co30Fe. The thickness preferably ranges between 0.4 nm and 1.4 nm, similar to inner ferromagnetic layer 91 made of CoFe.

Current limiting layer 92 includes low resistance magnetic regions 921 that are made of a ferromagnetic material and high resistance regions 922 having higher resistance to sense current than low resistance magnetic regions 921. High resistance regions 922 are distributed in low resistance magnetic regions 921 as if they were islands on the sea. Low resistance magnetic regions 921 electrically connect inner ferromagnetic layer 91 with outer ferromagnetic layer 193. Current limiting layer 92 preferably has a thickness ranging between 0.4 nm and 2 nm, as described later.

Low resistance magnetic regions 921 consist of a mixture of CoFe, Zn and oxygen (O), and high resistance regions 922 consist of ZnO, which is an n-type semiconductor. Because of this configuration, the sense current mainly flows through low resistance magnetic regions 921 having low electric resistance. The reason why Zn and O are contained in low resistance magnetic regions 921 is because a part of Zn elements and O elements can not form high resistance regions 922a, 922c in the form of a wurtzite structure, which is the normal structure of ZnO, and instead, they separately exist in the CoFe layer. High resistance regions 922 may be formed of ZnN, SiO, SiN, SiON, SiC, SnO, In₂O₃, ITO or TiO, in addition to ZnO.

Low resistance magnetic regions 921, which are ferromagnetic layers that include CoFe, have the same magnetic properties as inner ferromagnetic layer 91 and outer ferromagnetic layer 93 both of which also are ferromagnetic layers that include CoFe. Because of this configuration, sense current 22 can flow through low resistance magnetic regions 921 while keeping its spin selectivity so that both inner ferromagnetic layer 91 and outer ferromagnetic layer 93 behave as a single free layer 9. If low resistance magnetic regions 921 are formed of a nonmagnetic metal, as in the prior art, then the spin selectivity of sense current will be lost, and it will be difficult for outer ferromagnetic layer 93 to function as a part of free layer 9. This will cause an effect that is similar to a decrease in the net thickness of free layer 9, leading to a significant degradation of the magneto-resistance effect. In the present embodiment, because of the magnetic coupling between inner ferromagnetic layer 91 and outer ferromagnetic layer 93 via low resistance magnetic regions 921, which are ferromagnetic layers, outer ferromagnetic layer 93 functions as a part of free layer 9 and provides an increase in the magneto resistance ratio.

In addition, if a current limiting layer is formed by oxidizing a metal layer, as in the prior art, then conductive pillar layers will be formed in an insulating material. This configuration induces a shot noise caused by the tunneling magneto resistance (TMR) effect that occurs via the insulating material. Although the magneto resistance ratio is improved due to the current limiting effect, the signal to noise (S/N) ratio is worsened, and it will become impossible to maximize the effect of the increase in the magneto resistance ratio. In the present embodiment, however, high resistance regions 922 are formed of an n-type semiconductor. An n-type semiconductor advantageously enables an ohmic contact by allowing electrons to move from metal to semiconductor, and thereby prevents shot noise, as well as a reduction in the S/N ratio. Thus, the magneto resistance effect element according to the present embodiment can effectively utilize the effect of the increase in the magneto resistance ratio. The term “ohmic contact” refers to the metal-semiconductor contact wherein the metal has a higher Fermi level than the n-type semiconductor. The ohmic contact provides no energy barrier against electrons, allowing smooth current flow regardless of the direction of a voltage applied externally.

Referring to FIG. 2, cap layer 10 is provided in order to prevent MR stack 12 from being deteriorated. Cap layer 10 has a stack of a Ta layer and a Ru layer, which are conductive layers that allow sense current flowing from upper shield electrode layer 3 to pass therethrough.

Upper shield electrode layer 3 that is made of a NiFe layer having a thickness of about 1 μm is formed on cap layer 10.

A pair of bias magnetic films 13a, 13b is provided on both sides of MR stack 12 with regard to track width direction T. Bias magnetic films 13a, 13b serve as magnetic domain control films that apply a bias magnetic field to free layer 9 in track width direction T. The bias magnetic field magnetizes free layer 9 in track width direction T when free layer 9 is not subjected to an external magnetic field emitted from the recording medium. Bias magnetic films 13a, 13b are formed of CoCrPt or CoPt, but may be formed of a stack of a soft magnetic layer and an antiferromagnetic layer. Insulating layers 14a, 14b made of Al₂O₃ are provided between bias magnetic films 13a, 13b and MR stack 12 in order to prevent sense current 22 from flowing into bias magnetic films 13a, 13b.

Referring again to FIG. 1, write head portion 2 is provided above magnetic field detecting element 15 via inter-element shield layer 16 that is formed by means of sputtering or the like. Write head portion 2 has an arrangement for so-called perpendicular magnetic recording. Magnetic pole layers for writing have main magnetic pole layer 21 and auxiliary magnetic pole layer 22. These magnetic pole layers 21, 22 are formed by frame plating or the like. Main magnetic pole layer 21, which is made of FeCo, is exposed on air bearing surface ABS substantially perpendicularly thereto. Coil layer 23, which extends above gap layer 24 made of an insulating material, is wound around main magnetic pole layer 21 in order to induce a magnetic flux within main magnetic pole layer 21. Coil layer 23 is formed by means of frame plating or the like. The magnetic flux is guided inside main magnetic pole layer 21 and is emitted from air bearing surface ABS toward the recording medium. Main magnetic pole layer 21 is reduced in dimension not only in direction P that is perpendicular to the film plane but also in track width direction T (i.e., the direction that is perpendicular to the drawing of FIG. 1) in the vicinity of air bearing surface ABS, thereby producing a concentrated and intense writing magnetic field that realizes high recording density.

Auxiliary magnetic pole layer 22 is a magnetic layer that is magnetically coupled to main magnetic pole layer 21. Auxiliary magnetic pole layer 22 is a magnetic pole layer which has a thickness of about 0.01 to about 0.5 μm and which is made of an alloy that consists of any two of Ni, Fe, and Co or three thereof. Auxiliary magnetic pole layer 22 is branched from main magnetic pole layer 21 and is provided opposite to main magnetic pole layer 21 via gap layer 24 and coil insulating layer 25 at air bearing surface ABS. Auxiliary magnetic pole layer 22 has a trailing shield portion having a wider layer section than the rest of auxiliary magnetic pole layer 22 at the end portion that is on the side of air bearing surface ABS. Auxiliary magnetic pole layer 22 having such an arrangement provides a steeper magnetic field gradient between auxiliary magnetic pole layer 22 and main-magnetic pole layer 21 in the vicinity of air bearing surface ABS. As a result, it is possible to reduce signal output jitter, thereby to lower the error rate in reading.

The magneto resistance effect element is formed by forming lower shield electrode layer 4 on the substrate and then by stacking each layer that forms MR stack 12 sequentially on lower shield electrode layer 4. In this process, a ZnO layer that forms high resistance regions 922 is deposited, instead of current limiting layer 92. Then, an annealing process is performed at a temperature between about 200° C. and about 250° C. In the annealing process, aggregation of the ZnO layer and diffusion of Co and Fe elements in inner and outer ferromagnetic layers 91, 93 into the ZnO layer occur, forming low resistance magnetic regions 921 and high resistance regions 922. It should be noted that an annealing at a temperature of 250° C. or more reduces saturated magnetic field (Hs), the RA value (a product of element resistance R and element area A) and the magneto resistance ratio. Thereafter, MR stack 12 is formed into a predetermined shape by a pattering process; bias magnetic layers 13a, 13b are formed on both sides with regard to track width direction T; and an insulating layer is formed on the back side of MR stack 12, as viewed from the air bearing surface. Next, the layers are covered with upper shield electrode layer 3, and subsequently, write head portion 2 is formed according to a known method.

### Second Embodiment

The magneto resistance effect element of the second embodiment has the same configuration as that of the first embodiment except for the free layer. Table 1-2 shows the layer configuration of the MR stack according to the present embodiment. Table 1-2 is shown in the same manner as Table 1-1. The following description will be focused on the configuration of the free layer.

TABLE 1-2

| Layer Configuration | | | Composition | Thickness (nm) |
|---|---|---|---|---|
| Cap Layer 10 | | | Ta | 2 |
| | | | Ru | 1 |
| Free Layer 9 | Outer Ferromagnetic Layer 93 | | 90Co10Fe | 2 |
| (Second Magnetic Layer 9) | Current Limiting | Second Current Limiting Layer 92c | ZnO + CoFe | 0.2~1.0 |
| | Layer 92 | Low Resistance Magnetic Region Promoting Layer 92b | Zn, Co, Fe | 0.2~0.8 |
| | | First Current Limiting Layer 92a | ZnO + CoFe | 0.2~1.0 |

| | | | |
|---|---|---|---|
| | Inner Ferromagnetic Layer 91 | CoFe | 0.4~1.4 |
| Spacer Layer 8 | | Cu | 0.8 |
| Pinned Layer 7 | Second Pinned Lyer 73 | 30Co70Fe | 1.3 |
| (First Magnetic Layer 7) | | Cu | 0.2 |
| | | 30Co70Fe | 1.3 |
| | | 90Co10Fe | 1 |
| | Non-magnetic Intermediate Layer 72 | Ru | 0.8 |
| | First Pinned Lyer 71 | 70Co30Fe | 3 |

| | | |
|---|---|---|
| Anti-ferromagnetic Layer 6 | IrMn | 5.5 |
| Buffer Layer 5 | NiCr | 5 |
| | Ta | 1 |

FIG. 4 is a detailed cross sectional view of the free layer. Free layer 9 includes inner ferromagnetic layer 91 that is in contact with spacer layer 8, current limiting layer 92 that is in contact with inner ferromagnetic layer 91 on surface 91y that is opposite to surface 91x on which inner ferromagnetic layer 91 is in contact with spacer layer 8 and outer ferromagnetic layer 93 that is in contact with current limiting layer 92 on surface 92y that is opposite to surface 92x on which current limiting layer 92 is in contact with inner ferromagnetic layer 91.

Inner ferromagnetic layer 91 is formed of CoFe having a composition ranging between 90Co10Fe and 30Co70Fe. Inner ferromagnetic layer 91 preferably has a thickness from 0.4 nm to 1.4 nm, as described later. Inner ferromagnetic layer 91 may also be formed of CoFeB. In this case, the atomic fraction of boron (B) is preferably 20% or less. The composition of CoFe in CoFeB preferably ranges between 90Co10Fe and 70Co30Fe. The thickness preferably ranges between 0.4 nm and 1.4 nm, similar to inner ferromagnetic layer 91 made of CoFe.

Current limiting layer 92 includes a pair of current limiting layers (a first and a second current limiting layer 92a, 92c) and low resistance magnetic region promoting layer 92b, which is provided adjacent to and between the pair of current limiting layers 92a, 92c.

Current limiting layers 92a, 92c include low resistance magnetic regions 921a, 921c made of a ferromagnetic material and high resistance regions 922a, 922c having higher resistance to sense current 22 than low resistance magnetic regions 921a, 921c, respectively. High resistance regions 922a, 922c are distributed in low resistance magnetic regions 921a, 921c, respectively, as if they were islands on the sea. Low resistance magnetic regions 921a penetrate first current limiting layer 92a in which low resistance magnetic regions 921a are provided. Similarly, low resistance magnetic regions 921c penetrate second current limiting layer 92c in which low resistance magnetic regions 921c are provided. As described later, current limiting layers 92a, 92c each have a thickness ranging between 0.2 nm and 1 nm.

Low resistance magnetic regions 921a, 921c each consist of a mixture of CoFe, Zn and oxygen (O), and high resistance regions 922a, 922c consist of ZnO, which is an n-type semiconductor. Because of this configuration, the sense current mainly flows through low resistance magnetic regions 921a, 921c having low electric resistance. High resistance regions 922a, 922c may be formed of ZnN, SiO, SiN, SiON, SiC, SnO, In₂O₃, ITO or TiO, in addition to ZnO.

Low resistance magnetic region promoting layer 92b is formed of a mixture of Co, Fe, Zn and O. Low resistance magnetic region promoting layer 92b supplies material elements to low resistance magnetic regions 921a, 921c in first and second current limiting layers 92a, 92c adjacent thereto in order to promote the formation of low resistance magnetic regions 921a, 921c.

Outer ferromagnetic layer 93 is formed on second current limiting layer 92c. Similar to inner ferromagnetic layer 91, outer ferromagnetic layer 93 is formed of CoFe having a composition ranging between 90Co10Fe and 30Co70Fe. Outer ferromagnetic layer 93 preferably has a thickness ranging between about 1 nm and about 2 nm. Outer ferromagnetic layer 93 may also be formed of CoFeB. In this case, the atomic fraction of boron (B) is preferably 20% or less. The composition of CoFe in CoFeB preferably ranges between 90Co10Fe and 70Co30Fe. Similar to outer ferromagnetic layer 93 made of CoFe, the thickness preferably ranges between about 1 nm and about 2 nm.

For the same reason as in the first embodiment, the magneto resistance effect element according to the present embodiment is less apt to generate a shot noise and less apt to degrade the S/N ratio. Thus, the magneto resistance effect element according to the present embodiment can effectively utilize the effect of the increase in the magneto resistance ratio.

The magneto resistance effect element of the present embodiment is formed by stacking each layer that forms MR stack 12 sequentially on lower shield electrode layer 4. In this process, ZnO layers that form high resistance regions 922a, 922c are stacked, instead of first and second current limiting layers 92a, 92c. Then, an annealing process is performed at a temperature between about 200° C. and about 250° C. In the annealing process, aggregation of the ZnO layer and diffusion of Co and Fe elements in inner ferromagnetic layer 91 into the ZnO layer that is adjacent to inner ferromagnetic layer 91, as well as diffusion of Co and Fe elements in outer ferromagnetic layer 93 into the ZnO layer that is adjacent to outer ferromagnetic layer 93 occur, forming low resistance magnetic regions 921a, 921c and high resistance regions 922a, 922c.

In the magneto resistance effect element of the present embodiment, low resistance magnetic region promoting layer 92b is inserted into the ZnO layer. Thus, Co and Fe elements also diffuse into the adjacent ZnO layer from low resistance magnetic region promoting layer 92b. In general, Co and Fe elements have a diffusion length of several nanometers. Therefore, Co and Fe elements easily diffuse into the regions of the ZnO layer that are adjacent to inner ferromagnetic layer 91 or outer ferromagnetic layer 93, and thereby promote the formation of low resistance magnetic regions 921a, 921c. However, Co and Fe elements are less apt to reach the regions of the ZnO layer that are away from inner ferromagnetic layer 91 or outer ferromagnetic layer 93, which may lead to insufficient formation of low resistance magnetic regions 921a, 921c. In the present embodiment, however, low resistance magnetic region promoting layer 92b that is inserted into the ZnO layer promotes the diffusion of Co and Fe elements from inside of the ZnO layer and the formation of low resistance magnetic regions 921a, 921c.

As described above, low resistance magnetic region promoting layer 92b also includes Zn and O (oxygen). As described above, a part of Zn elements and O elements can not form a wurtzite structure, which is the normal structure of ZnO, and instead, they separately exist in the CoFe layer. Accordingly, low resistance magnetic regions 921a, 921c in 92a, 92c are formed of a mixture of CoFe, Zn and O. For this reason, low resistance magnetic region promoting layer 92b is formed of a mixture of Co, Fe, Zn and O taking into account the actual composition of low resistance magnetic regions 921a, 921c.

In the first and the second embodiments, only the free layer has the current limiting layer. However, the pinned layer, instead of or together with the free layer, may have the same layer configuration as the free layer. In this case, the MR stack may have the layer configuration, such as the one shown in Table 1-3.

Furthermore, free layer 9 is stacked above pinned layer 7 in the first and the second embodiments. However, pinned layer 7 may be stacked above free layer 9. In this case, antiferromagnetic layer 6, pinned layer 7 and free layer 9 in the layer configuration shown in Tables 1-1 to 1-3 are arranged in mirror symmetry with respect to spacer layer 8.

TABLE 1-3

| Layer Configuration | | | Composition | Thickness (nm) |
|---|---|---|---|---|
| Cap Layer 10 | | | Ta | 2.0 |
| | | | Ru | 1.0 |
| Free Layer 9 | Outer Ferromagnetic Layer 93 | | 90CoFe | 2.0 |
| (Second Magnetic Layer 9) | Current Limiting | Second Current Limiting Layer 92c | Zn0 + CoFe | 0.2~1.0 |
| | Layer 92 | Low Resistance Magnetic Region Promoting Layer 92b | Zn, Co, Fe | 0.2~0.8 |
| | | First Current Limiting Layer 92a | Zn0 + CoFe | 0.2~1.0 |
| | Inner Ferromagnetic Layer 91 | | CoFe | 0.4~1.4 |
| Spacer Layer 8 | | | Cu | 0.8 |
| Pinned Layer 7 | Inner Ferromagnetic Layer | | CoFe | 0.4~1.4 |
| (First Magnetic Layer 7) | Current Limiting | Second Current Limiting Layer | Zn0 + CoFe | 0.2~1.0 |
| | Layer | Low Resistance Magnetic Region Promoting Layer | Zn, Co, Fe | 0.2~0.8 |
| | | First Current Limiting Layer | Zn0 + CoFe | 0.2~1.0 |

| | | |
|---|---|---|
| 0uter Ferromagnetic Layer | 90CoFe | 1.0 |
| First Pinned Lyer 71 | 70CoFe | 1.0 |

| | | |
|---|---|---|
| Anti-ferromagnetic Layer 6 | IrMn | 5.5 |
| Buffer Layer 5 | NiCr | 5.0 |
| | Ta | 1.0 |

### Third Embodiment

The third embodiment is different from the first embodiment in that the magnetization directions of both the first and the second magnetic layers that interpose the spacer layer vary according to an external magnetic field. The basic configuration of a thin-film magnetic head, which is illustrated in FIG. 1, is the same as that of the first embodiment, and therefore, the following description will be focused on the configuration of the magneto resistance effect element.

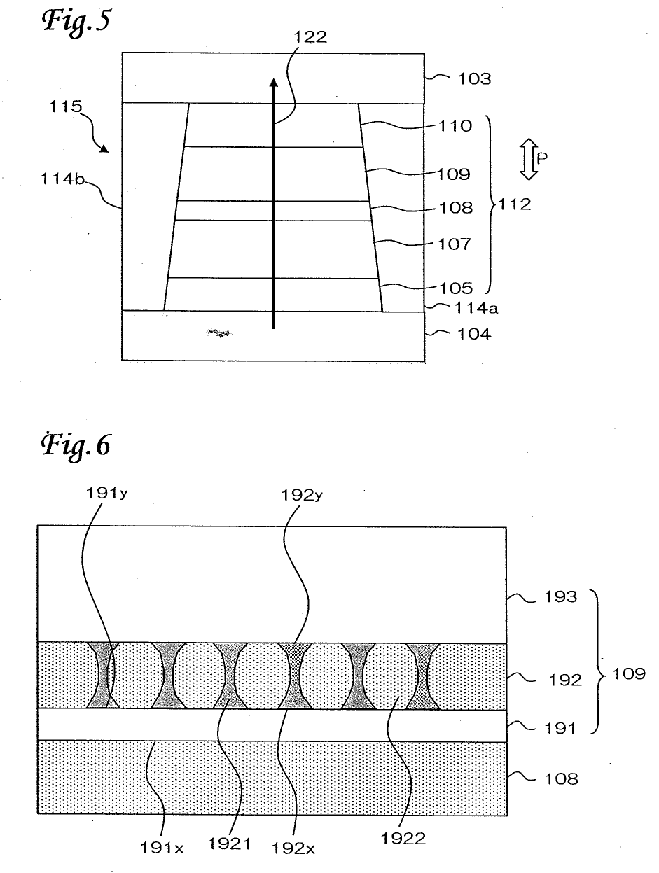

FIG. 5 is an enlarged view of the main portion of the air bearing surface of magneto resistance effect element 115 according to the present embodiment. Table 2-1 shows the layer configuration of MR stack 112. In the table, the layers are shown in the order of stacking from the bottom row to the top row, starting with buffer layer 105, which is located on the side of lower shield electrode layer 104, toward cap layer 110, which is located on the side of upper shield electrode layer 103. In the table, the numerals in the column of “Composition” indicate the atomic percents of the elements. MR stack 112 has buffer layer 105, first magnetic layer 107, spacer layer 108, second magnetic layer 109 and cap layer 110 formed on lower shield electrode layer 104, made of NIFe, in this order.

TABLE 2-1

| Layer Configuration | | Composition | Thickness (nm) |
|---|---|---|---|
| Cap Layer 110 | | Ta | 2 |
| | | Ru | 1 |
| Second Magnetic Layer 109 | Outer Ferromagnetic Layer 193 | CoFe | 2 |
| | Current Limiting Layer 192 | ZnO + CoFe | 0.4~2.0 |
| | Inner Ferromagnetic Layer 191 | CoFe | 0.4~1.4 |

| | | |
|---|---|---|
| Spacer Layer 108 | Cu | 0.8 |
| First Magnetic Layer 107 | 90Co10Fe | 1 |
| | NiFe | 4 |
| | 90Co10Fe | 1 |
| Buffer Layer 105 | NiCr | 5 |
| | Ta | 1 |

Buffer layer 105 has a stack of a metallic layer made of Ta and a seed layer made of NiCr. Alternatively, buffer layer 105 may be a single layer made of NiCr.

First magnetic layer 107 is provided on buffer layer 105. First magnetic layer 107 may be formed of a stack of a CoFe layer and a NiF layer, a single layer made of 70Co30Fe (thickness of 2-4 nm), a stack of a 90Co10Fe layer (thickness of 0.5-2 nm)/a 82Ni18Fe layer (thickness of 1-2 nm)/a 90Co10Fe layer (thickness of 0.5-2 nm) or a stack of a 90Co10Fe layer (thickness of 1-5 nm)/a CoFeB layer (thickness of 0.2-1 nm)/a 30Co70Fe layer (thickness of 1-5 nm). When a CoFeB layer is used, the atomic fraction of boron (B) is preferably 20% or less, and the composition of CoFe in CoFeB is preferably 90Co10Fe

Similar to the first embodiment, spacer layer 108 is made of Cu and has a thickness of about 0.8 nm. Spacer layer 108 may have other configurations described in the first embodiment. First magnetic layer 107 is antiferromagnetically coupled with second magnetic layer 109 via spacer layer 108.

FIG. 6 is a detailed cross sectional view of the free layer. Free layer 109 includes inner ferromagnetic layer 191 that is in contact with spacer layer 108, current limiting layer 192 that is in contact with inner ferromagnetic layer 191 on surface 191y that is opposite to surface 191x on which inner ferromagnetic layer 191 is in contact with spacer layer 108 and outer ferromagnetic layer 193 that is in contact with current limiting layer 192 on surface 192y that is opposite to surface 192x on which current limiting layer 192 is in contact with inner ferromagnetic layer 191.

Inner ferromagnetic layer 191 is formed of CoFe having a composition ranging between 90Co10Fe and 30Co70Fe. Inner ferromagnetic layer 191 preferably has a thickness from 0.4 nm to 1.4 nm, as described later. Inner ferromagnetic layer 191 may also be formed of CoFeB. In this case, the atomic fraction of boron (B) is preferably 20% or less. The composition of CoFe in CoFeB preferably ranges between 90Co10Fe and 70Co30Fe. The thickness preferably ranges between 0.4 nm and 1.4 nm, similar to inner ferromagnetic layer 191 made of CoFe.

Current limiting layer 192 includes low resistance magnetic regions 1921 that are made of a ferromagnetic material and high resistance regions 1922 having higher resistance to sense current than low resistance magnetic regions 1921. High resistance regions 1922 are distributed in low resistance magnetic regions 1921 as if they were islands on the sea. Low resistance magnetic regions 1921 electrically connect inner ferromagnetic layer 191 with outer ferromagnetic layer 193. Current limiting layer 192 preferably has a thickness ranging between 0.4 nm and 2 nm, as described later.

Low resistance magnetic regions 1921 consist of a mixture of CoFe, Zn and oxygen (O), and high resistance regions 1922 consist of ZnO, which is an n-type semiconductor. Because of this configuration, the sense current mainly flows through low resistance magnetic regions 1921 having low electric resistance. High resistance regions 1922 may be formed of ZnN, SiO, SiN, SION, SiC, SnO, In₂O₃, ITO or TiO, in addition to ZnO.

Since low resistance magnetic regions 1921 are ferromagnetic layers that include CoFe, inner ferromagnetic layer 191 is magnetically coupled with outer ferromagnetic layer 193 via low resistance magnetic regions 1921, which are made of ferromagnetic layers, for the same reason as in the first embodiment. This configuration enables outer ferromagnetic layer 193 to function as part of free layer 109, leading to an increase in the magneto resistance ratio. Furthermore, the magneto resistance effect element according to the present embodiment is less apt to generate a shot noise and less apt to degrade the S/N ratio for the same reason as in the first embodiment, enabling an effective use of the effect of the increase in the magneto resistance ratio.

Cap layer 110 is provided in order to prevent MR stack 112 from being deteriorated. Cap layer 110 has a stack of a Ta layer and a Ru layer, which are conductive layers that allow sense current 122 flowing from upper shield electrode layer 103 to pass therethrough.

Upper shield electrode layer 103 that is made of a NiFe layer having a thickness of about 1 μm is formed on cap layer 110.

Insulating layers 114a, 114b made of Al₂O₃ are formed on both sides of MR stack 112 with regard to track width direction T. Insulating layers 114a, 114b enables concentration of sense current 122 on MR stack 112.

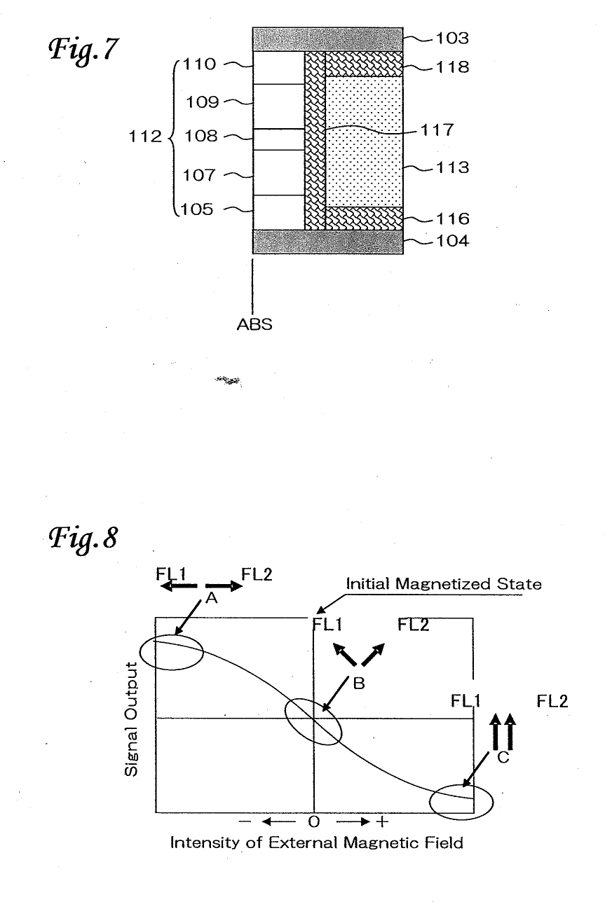

FIG. 7 is a cross sectional view of the magneto resistance effect element, viewed from the same direction as in FIG. 1. Bias magnetic film 113 is provided on the back side of MR stack 112, viewed from air bearing surface ABS. Bias magnetic film 113 is a magnetic domain controlling film that applies a bias magnetic field to first and second magnetic layers 107, 109 in the direction that is perpendicular to air bearing surface ABS. Bias magnetic film 113 may be formed of CoCrPt, CoPt or the like, or may be formed of a stack of a soft magnetic layer and an antiferromagnetic layer. Insulating layer 117 formed of Al₂O₃ is provided between bias magnetic film 113 and MR stack 112 to prevent sense current 122 from flowing into bias magnetic film 113. Furthermore, insulating layer 116 is provided between bias magnetic film 113 and upper shield electrode layer 103, and insulating layer 118 is provided between bias magnetic film 113 and lower shield electrode layer 104. Insulating layers 116, 118 also prevent sense current 122 from flowing into bias magnetic film 113.

FIG. 8 is a schematic diagram illustrating the working principle of a magnetic detecting element of the present embodiment. The abscissa denotes intensity of an external magnetic field, and the ordinate represents signal output. In the figure, the magnetization directions of first and second magnetic layers 107, 109 are represented by FL1 and FL2, respectively. When neither a bias magnetic field applied from bias magnetic field layer 113 nor an external magnetic field applied from a recording medium exist, the magnetization directions of first and second magnetic layers 107, 109 are anti-parallel to each other due to the above-mentioned antiferromagnetic coupling (refer to portion A in the figure). However, because of the bias magnetic field that is applied actually, the magnetization directions of first and second magnetic layers 107, 109 rotate from the anti-parallel state toward a parallel state, going into an intermediate state between the anti-parallel state and the parallel state (refer to portion B in the figure), and form an initial magnetization state (or a state in which only a bias magnetic field is applied). An application of an external magnetic field from a recording medium under this state increases the relative angle between the magnetization directions of first and second magnetic layers 107, 109 (the magnetization directions approach the anti-parallel state.) or decreases the relative angle (the magnetization directions approach the parallel state.) depending on the direction of the magnetic field. If the magnetization state comes close to the anti-parallel state, then electrons emitted from the electrode are apt to be scattered more, and an increase in the electric resistance of the sense current is obtained. If the magnetization state comes close to the parallel state, then electrons emitted from electrode are less apt to be scattered, and a decrease in the electric resistance of the sense current is obtained. In this way, by utilizing the change in the relative angle between the magnetization direction of first and second magnetic layers 107, 109, an external magnetic field can be detected.

The magneto resistance effect element of the third embodiment can be produced by substantially the same method as used in the first embodiment. Specifically, each layer that forms MR stack 112 is sequentially stacked on lower shield electrode layer 104. In this process, a ZnO layer that forms the high resistance regions is deposited, instead of current limiting layer 192. In the annealing process performed at a temperature between about 200° C. and about 250° C., aggregation of the ZnO layer and diffusion of Co and Fe elements in inner and outer ferromagnetic layers 191, 193 into the ZnO layer occur, forming low resistance magnetic regions 1921 and high resistance regions 1922.

In the present embodiment, only second magnetic layer 109 has current limiting layer 192. However, first magnetic layer 107, instead of or together with second magnetic layer 109, may have the same layer configuration as second magnetic layer 109. In this case, first magnetic layer 107 has a layer configuration that is in mirror symmetry of second magnetic layer 109 shown in Table 2-1 with respect to spacer layer 108.

### Forth Embodiment

The fourth embodiment has the same layer configuration as the third embodiment except that a low resistance magnetic region promoting layer is inserted into the current limiting layer of the second magnetic layer. Therefore, the following description will be focused on the configuration of the second magnetic layer.

Table 2-2 shows the layer configuration of MR stack 112. Second magnetic layer 109 may have the same configuration as free layer 9 of the second embodiment. Outer ferromagnetic layer 193 of the present embodiment is formed of a stack of a CoFe layer and a NiFe layer, differently from outer ferromagnetic layer 93 of the second embodiment that is formed of a CoFe layer. The other portions of second magnetic layer 109 have the same configuration as the second embodiment.

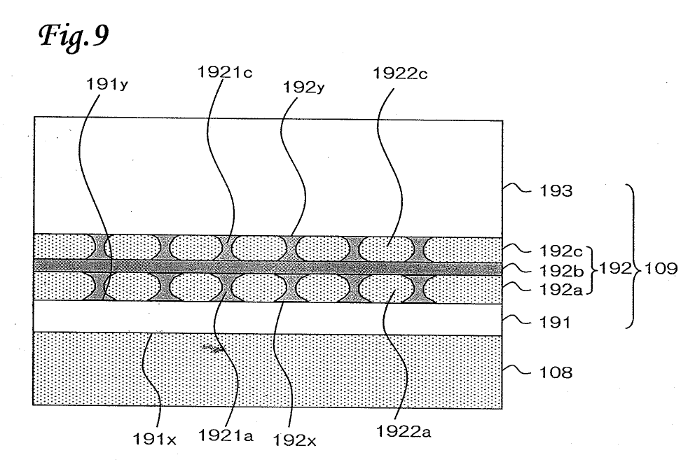

FIG. 9 is a detailed cross sectional view of the free layer. Free layer 109 includes inner ferromagnetic layer 191 that is in contact with spacer layer 108, current limiting layer 192 that is in contact with inner ferromagnetic layer 191 on surface 191y that is opposite to surface 191x on which inner ferromagnetic layer 191 is in contact with spacer layer 108 and outer ferromagnetic layer 193 that is in contact with current limiting layer 192 on surface 192y that is opposite to surface 192x on which current limiting layer 192 is in contact with inner ferromagnetic layer 191.

TABLE 2-2

| Layer Configuration | | | Composition | Thickness (nm) |
|---|---|---|---|---|
| Cap Layer 110 | | | Ta | 2 |
| Second Magnetic Layer 109 | Outer Ferromagnetic Layer 193 | | NiFe | 4 |
| | | | 90Co10Fe | 1 |
| | Current Limiting | Second Current Limiting Layer 192c | ZnO + CoFe | 0.2~1.0 |
| | Layer 192 | Low Resistance Magnetic Region Promoting Layer 192 | Zn, Co, Fe | 0.2~0.8 |
| | | First Current Limiting Layer 192a | ZnO + CoFe | 0.2~1.0 |

| | | |
|---|---|---|
| Inner Ferromagnetic Layer 191 | CoFe | 0.4~1.4 |

| | | |
|---|---|---|
| Spacer Layer 108 | Cu | 0.8 |
| First Magnetic Layer 107 | CoFe | 2 |
| | NiFe | 4 |
| Buffer Layer 105 | NiCr | 5 |
| | Ta | 1 |

Inner ferromagnetic layer 191 is formed of CoFe having a composition ranging between 90Co10Fe and 30Co70Fe. Inner ferromagnetic layer 191 preferably has a thickness from 0.4 nm to 1.4 nm, as described later. Inner ferromagnetic layer 191 may also be formed of CoFeB. In this case, the atomic fraction of boron (B) is preferably 20% or less. The composition of CoFe in CoFeB preferably ranges between 90Co10Fe and 70Co30Fe. The thickness preferably ranges between 0.4 nm and 1.4 nm, similar to inner ferromagnetic layer 191 made of CoFe.

Current limiting layer 192 includes a pair of current limiting layers (first and second current limiting layer 192a, 192c) and low resistance magnetic region promoting layer 192b, which is provided adjacent to and between the pair of current limiting layers 192a, 192c.

Current limiting layers 192a, 192c include low resistance magnetic regions 1921a, 1921c made of a ferromagnetic material and high resistance regions 1922a, 1922c having higher resistance to sense current than low resistance magnetic regions 1921a, 1921c, respectively. High resistance regions 1922a, 1922c are distributed in low resistance magnetic regions 1921a, 1921c, respectively, as if they were islands on the sea. Low resistance magnetic regions 1921a penetrate first current limiting layer 192a in which low resistance magnetic regions 1921a are provided. Similarly, low resistance magnetic regions 1921c penetrate second current limiting layer 192c in which low resistance magnetic regions 1921c are provided. As described later, current limiting layers 192a, 192c each have a thickness ranging between 0.2 nm and 1 nm.

Low resistance magnetic regions 1921a, 1921c each consist of a mixture of CoFe, Zn and oxygen (O), and high resistance regions 1922a, 1922c consist of ZnO, which is an n-type semiconductor. Because of this configuration, the sense current mainly flows through low resistance magnetic regions 1921a, 1921c having low electric resistance. High resistance regions 1922a, 1922c may be formed of ZnN, SiO, SiN, SiON, SiC, SnO, In₂O₃, ITO or TiO, in addition to ZnO.

The present embodiment is advantageous in that high resistance regions 1922a, 1922c are formed of an n-type semiconductor which is less apt to generate a shot noise and less apt to degrade the S/N ratio for the same reason as in the first embodiment. Thus, the magneto resistance effect element according to the present embodiment can effectively utilize the effect of the increase in the magneto resistance ratio.

Low resistance magnetic region promoting layer 192b is formed of a mixture of Co, Fe, Zn and O. Low resistance magnetic region promoting layer 192b supplies material elements to low resistance magnetic regions 1921a, 1921c in first and second current limiting layers 192a, 192c adjacent thereto in order to promote the formation of low resistance magnetic regions 1921a, 1921c.

Outer ferromagnetic layer 193 is formed on second current limiting layer 192c. Similar to inner ferromagnetic layer 191, outer ferromagnetic layer 193 has a stack of a CoFe layer having a composition ranging between 90Co10Fe and 30Co70Fe and a NiFe layer. The CoFe layer preferably has a thickness ranging between about 1 nm and about 2 nm. A CoFeB layer may be used instead of the CoFe layer. In this case, the atomic fraction of boron (B) is preferably 20% or less. The composition of CoFe in CoFeB preferably ranges between 90Co10Fe and 70Co30Fe. Similar to outer ferromagnetic layer 193 made of CoFe, the thickness preferably ranges between about 1 nm to about 2 nm.

The magneto resistance effect element of the fourth embodiment can be produced according to substantially the same method as used in the first embodiment. Specifically, each layer forming MR stack 112 is sequentially stacked on lower shield electrode layer 104. In this process, ZnO layers that form high resistance regions 1922a, 1922c are stacked, instead of first and second current limiting layers 192a, 192c. Then, an annealing process is performed at a temperature between about 200° C. and about 250° C. In the annealing process, aggregation of the ZnO layers and diffusion of Co and Fe elements in inner ferromagnetic layer 191 into the ZnO layer that is adjacent to inner ferromagnetic layer 191, as well as diffusion of Co and Fe elements in outer ferromagnetic layer 193 into the ZnO layer that is adjacent to outer ferromagnetic layer 193 occur, forming low resistance magnetic regions 1921a, 1921c and high resistance regions 1922a, 1922c.

Also in the present embodiment, first magnetic layer 107, instead of or together with second magnetic layer 109, may have the same layer configuration as second magnetic layer 109, similar to the third embodiment. In this case, first magnetic layer 107 has a layer configuration that is in mirror symmetry of second magnetic layer 109 shown in Table 2-2 with respect to spacer layer 108.

Next, a study was conducted on the preferable ranges of the film thicknesses of inner ferromagnetic layer 191 and the current limiting layer in the layer configuration of the third embodiment. The thickness of the ZnO layer is used as an actual parameter because the current limiting layer is formed in the annealing process, as described above. However, the thickness of the ZnO layer is considered to be substantially equal to the thickness of the current limiting layer.

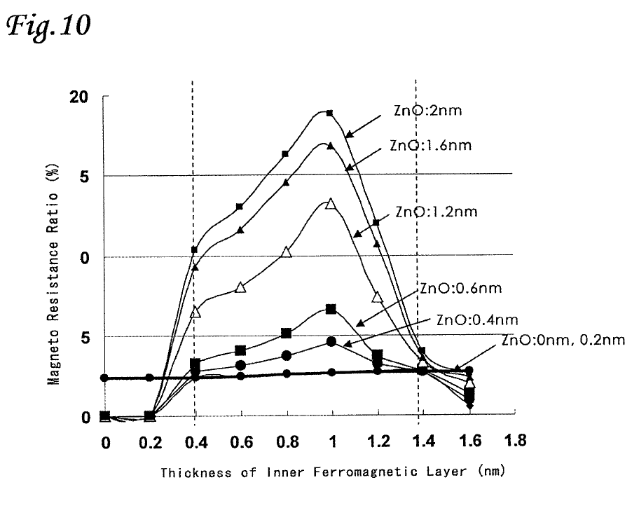

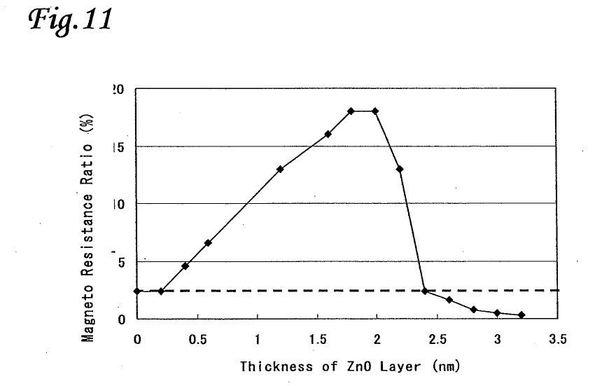

The thickness of inner ferromagnetic layer 191 was varied from 0 nm to 1.6 nm and the thickness of the ZnO layer was varied from 0 nm to 2 nm. Assuming the case in which the ZnO layer has a thickness of 0 nm, i.e., the case in which the current limiting layer is not provided, as a reference case, a case in which the magneto resistance ratio exceeds the value for the reference case was regarded as having the effect of the present invention. Referring to FIG. 10, it is found that inner ferromagnetic layer 191 having a thickness between 0.4 nm and 1.4 nm shows a magneto resistance ratio that exceeds the value for the reference case when the ZnO layer has a thickness of 0.4 nm or more. The ZnO layer having a thickness of 0.2 nm shows the same magneto resistance ratio as the reference case. As the thickness of the ZnO layer becomes large, the current limiting effect is improved and the magneto resistance ratio is increased. However, an excessive increase in the thickness of the ZnO layer causes the outer ferromagnetic layer to be magnetically decoupled from the inner ferromagnetic layer, conversely leading to a decrease in the magneto resistance ratio. Thus, the upper limit of the thickness of the ZnO layer was studied by measuring the magneto resistance ratio for the thickness range of the ZnO layer up to 3.2 nm, while keeping the thickness of inner ferromagnetic layer 191 to be a constant value of 1 nm. The measurement result is shown in FIG. 11. The result shows that the magneto resistance ratio sharply drops when the thickness of the ZnO layer exceeds 2 nm, and the magneto resistance ratio corresponds to substantially the same value as the value for reference case at the thickness of 2.4 nm.

Based on the above result, the thickness of the current limiting layer (the ZnO layer) preferably ranges between 0.4 nm and 2 nm, and the thickness of inner ferromagnetic layer 191 (the CoFe layer) preferably ranges between 0.4 nm and 1.4 nm.

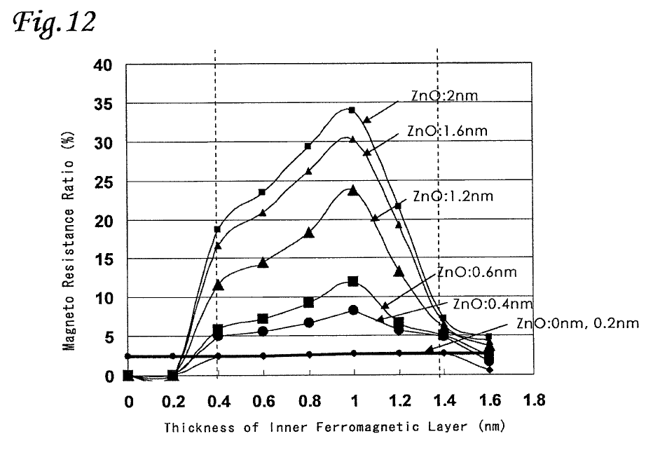

Next, a study was conducted on the preferable ranges of the film thicknesses of inner ferromagnetic layer 191 and the current limiting layer in the layer configuration of the fourth embodiment. Low resistance magnetic region promoting layer 192b was inserted into current limiting layer 192 at the midpoint of the thickness thereof. The thickness of current limiting layer (the ZnO layer) is defined as a value that is obtained by subtracting the thickness of low resistance magnetic region promoting layer 192b from the distance between the upper and the lower surfaces of current limiting layer 192. In other words, the half value of the thickness of the ZnO layer shown in FIG. 12 corresponds to the thickness of first and second current limiting layers 192a, 192c.

It is found that FIG. 12 provides a tendency that is similar to FIG. 10, although the fourth embodiment shows a higher absolute value of the magneto resistance ratio than the third embodiment. The comparison of the maximum value of the curves for each thickness of the ZnO layer shows that the fourth embodiment exhibits about 1.8 times as large the magneto resistance ratio as the third embodiment. This is considered to be the result of inserting the low resistance magnetic region promoting layer that ensures formation of the low resistance magnetic regions in the current limiting layer and that thereby provides an appropriate RA value, as described above. For this reason, the variation (standard deviation) in the magneto resistance ratio among the elements was lowered from 10%, which is a conventional deviation, to about 3%. In general, Co and Fe are said to be most apt to diffuse within the depth of approximately 0.4 nm. Consequently, by inserting the low resistance magnetic region promoting layer into the ZnO layer, for example, having a thickness of 1.6 nm at the midpoint thereof, the entire area of the ZnO layer is within 0.4 nm from the inner ferromagnetic layer, the outer ferromagnetic layer or the low resistance magnetic region promoting layer, and a sufficient diffusion effect is expected. As is apparent from the above description, it is desirable that low resistance magnetic region promoting layer 192b is positioned at the midpoint of the thickness of current limiting layer 192.

It should be noted that the optimum thicknesses of the current limiting layer and the inner ferromagnetic layer mentioned above, which are applied to the third and the fourth embodiments, are also applicable to the first and the second embodiments that basically have the same configuration of the current limiting layer.

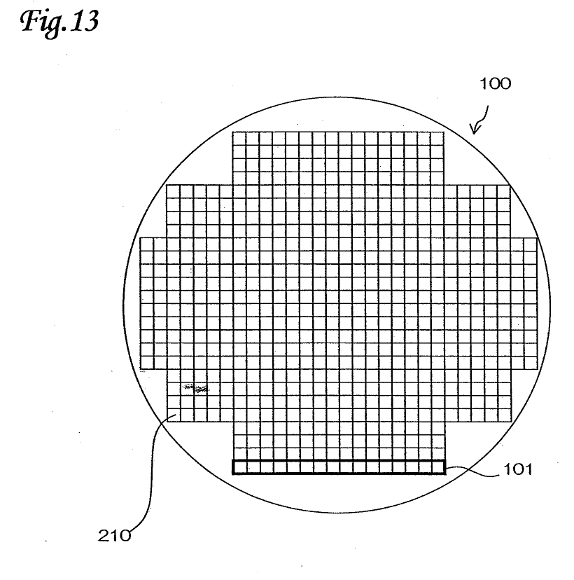

Next, explanation will be made regarding a wafer for fabricating a magneto resistance effect element described above. Referring to FIG. 13, wafer 100 has MR stack 12, 112 deposited thereon that constitutes at least magneto resistance effect element 15, 115 described above. Wafer 100 is diced into bars 101 which serve as working units in the process of forming air bearing surface ABS. After lapping, bar 101 is diced into sliders 210 which include thin-film magnetic heads 1. Dicing portions, not shown, are provided in wafer 100 in order to dice wafer 100 into bars 101 and into sliders 210.

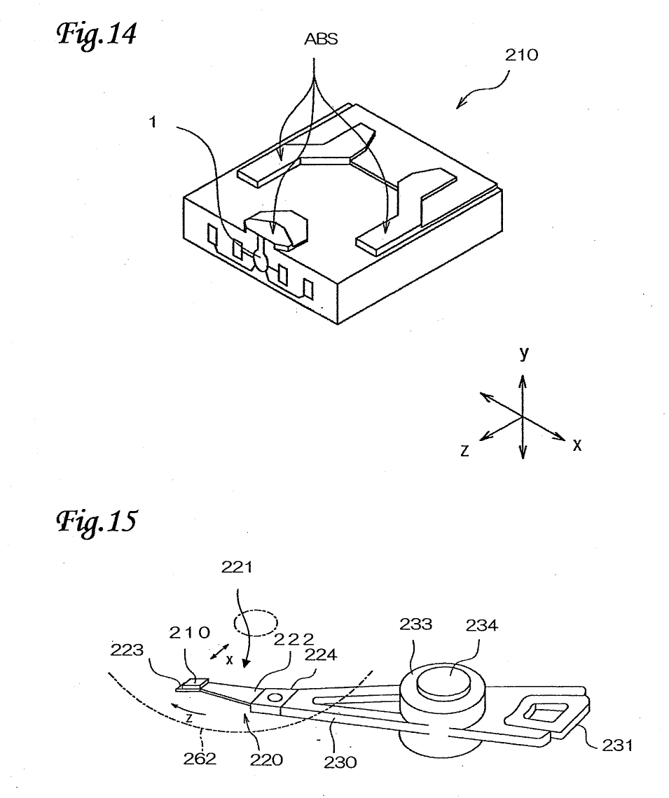

Referring to FIG. 14, slider 210 has a substantially hexahedral shape. One surface out of six the surfaces of slider 210 forms air bearing surface ABS, which is positioned opposite to the hard disk.

Referring to FIG. 15, head gimbal assembly 220 has slider 210 and suspension 221 for resiliently supporting slider 210. Suspension 221 has load beam 222 in the shape of a flat spring and made of, for example, stainless steel, flexure 223 that is attached to one end of load beam 222, and base plate 224 provided on the other end of load beam 222. Slider 210 is fixed to flexure 223 to provide slider 210 with an appropriate degree of freedom. The portion of flexure 223 to which slider 210 is attached has a gimbal section for maintaining slider 210 in a fixed orientation.

Slider 210 is arranged opposite to a hard disk, which is a rotationally-driven disc-shaped storage medium, in a hard disk drive. When the hard disk rotates in the z direction shown in FIG. 15, airflow which passes between the hard disk and slider 210 creates a dynamic lift, which is applied to slider 210 downward in the y direction. Slider 210 is configured to lift up from the surface of the hard disk due to this dynamic lift effect. Magneto resistance effect element 15, 115 is formed in proximity to the trailing edge (the end portion at the lower left in FIG. 14) of slider 210, which is on the outlet side of the airflow.

The arrangement in which a head gimbal assembly 220 is attached to arm 230 is called a head arm assembly 221. Arm 230 moves slider 210 in transverse direction x with regard to the track of hard disk 262. One end of arm 230 is attached to base plate 224. Coil 231, which constitutes a part of a voice coil motor, is attached to the other end of arm 230. Bearing section 233 is provided in the intermediate portion of arm 230. Arm 230 is rotatably held by shaft 234 which is attached to bearing section 233. Arm 230 and the voice coil motor to drive arm 230 constitute an actuator.

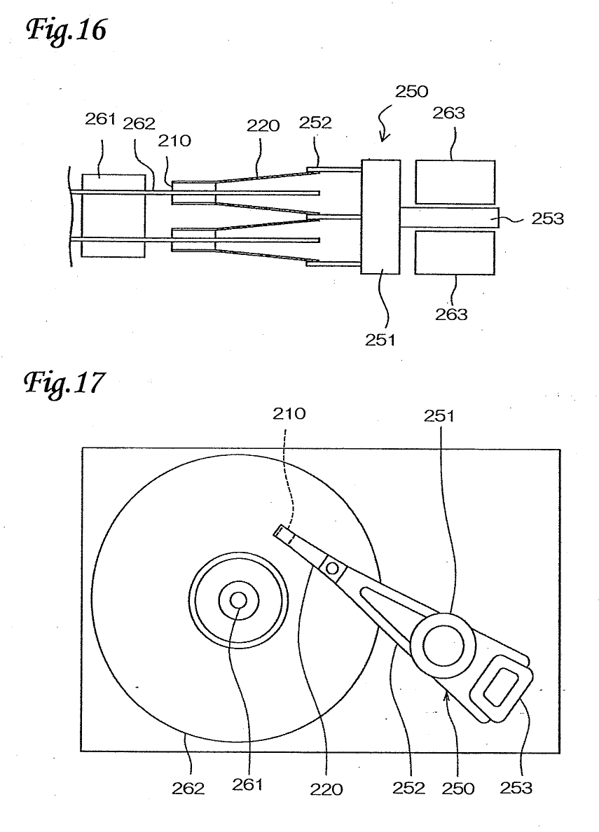

Referring to FIG. 16 and FIG. 17, a head stack assembly and a hard disk drive that incorporate the slider mentioned above will be explained next. The arrangement in which head gimbal assemblies 220 are attached to the respective arm of a carriage having a plurality of arms is called a head stack assembly. FIG. 16 is a side view of a head stack assembly, and FIG. 17 is a plan view of a hard disk drive. Head stack assembly 250 has carriage 251 provided with a plurality of arms 252. Head gimbal assemblies 220 are attached to arms 252 such that head gimbal assemblies 220 are arranged apart from each other in the vertical direction. Coil 253, which constitutes a part of the voice coil motor, is attached to carriage 251 on the side opposite to arms 252. The voice coil motor has permanent magnets 263 which are arranged in positions that are opposite to each other and interpose coil 253 therebetween.

Referring to FIG. 17, head stack assembly 250 is installed in a hard disk drive. The hard disk drive has a plurality of hard disks which are connected to spindle motor 261. Two sliders 210 are provided per each hard disk 262 at positions which are opposite to each other and interpose hard disk 262 therebetween. Head stack assembly 250 and the actuator, except for sliders 210, work as a positioning device in the present invention. They carry sliders 210 and work to position sliders 210 relative to hard disks 262. Sliders 210 are moved by the actuator in the transverse direction with regard to the tracks of hard disks 262, and positioned relative to hard disks 262. Magneto resistance effect element 15 that is included in slider 210 writes information to hard disk 262 by means of the write head portion, and reads information recorded in hard disk 262 by means of the read head portion.

Although certain preferred embodiments of the present invention have been shown and described in detail, it should be understood that various changes and modifications may be made without departing from the spirit or scope of the appended claims.

1. A magneto resistance effect element comprising a first magnetic layer, a second magnetic layer and a spacer layer interposed between said first and second magnetic layers,
wherein said magneto resistance effect element is configured to allow sense current to flow in a direction that is perpendicular to film planes of the first magnetic layer, the second magnetic layer and the spacer layer so that a relative angle between a magnetization direction of said first magnetic layer and a magnetization direction of said second magnetic layer varies depending on an external magnetic field,
wherein at least said first magnetic layer or said second magnetic layer includes:
an inner ferromagnetic layer that is in contact with said spacer layer;
a current limiting layer that is in contact with said inner ferromagnetic layer on a surface of said inner ferromagnetic layer, said surface being opposite to a surface of said inner ferromagnetic layer on which said inner ferromagnetic layer is in contact with said spacer layer; and
an outer ferromagnetic layer that is in contact with said current limiting layer on a surface of said current limiting layer, said surface being opposite to a surface of said current limiting layer on which said current limiting layer is in contact with said inner ferromagnetic layer,
wherein said current limiting layer includes:
low resistance magnetic regions that are formed of a ferromagnetic material that includes an element that is common to said inner ferromagnetic layer and to said outer ferromagnetic layer; and
high resistance regions having higher resistance to the sense current than said low resistance magnetic regions; and
wherein said low resistance magnetic regions electrically connect said inner ferromagnetic layer with said outer ferromagnetic layer.

2. The magneto resistance effect element according to claim 1, wherein said high resistance regions are formed of an n-type semiconductor.

3. The magneto resistance effect element according to claim 1, wherein a low resistance magnetic region promoting layer is inserted into said current limiting layer, said low resistance magnetic region promoting layer including an element that is common both to said inner ferromagnetic layer and to said outer ferromagnetic layer.

4. The magneto resistance effect element according to claim 3, wherein the common elements are cobalt and iron.

5. The magneto resistance effect element according to claim 1, wherein said outer and said inner ferromagnetic layers include a mixture of cobalt and iron, said high resistance regions are formed of ZnO, and said low resistance magnetic region promoting layer includes a mixture of cobalt, iron, zinc and oxygen.

6. The magneto resistance effect element according to claim 5, wherein said current limiting layer has a thickness that ranges between 0.4 nm and 2 nm and said inner ferromagnetic layer has a thickness that ranges between 0.4 nm and 1.4 nm.

7. The magneto resistance effect element according to claim 1, wherein either said first or said second magnetic layer is a free layer whose magnetization direction varies according to an external magnetic field, and the other thereof is a pinned layer whose magnetization direction is fixed with respect to the external magnetic field.

8. The magneto resistance effect element according to claim 1, wherein both said first and said second magnetic layer are free layers whose magnetization directions vary according to an external magnetic field.

9. A slider comprising the magneto resistance effect element according to claim 1.

10. A wafer having a stack formed thereon, wherein said stack is to be formed into the magneto resistance effect element according to claim 1.

11. A head gimbal assembly comprising the slider according to claim 9 and a suspension for resiliently supporting said slider.

12. A hard disk drive comprising the slider according to claim 9 and an element for supporting said slider and for positioning said slider with respect to a recording medium.

13. A magnetic head comprising the magneto resistance effect element according to claim 1
